(19) United States
(12) Patent Application Publication
(10) Pub. No.: US 2016/0176025 A1
(43) Pub. Date: Jun. 23, 2016

(54) PIPE WRENCH HAVING CHANGEABLE ENGAGING SURFACE

(71) Applicant: Troy Houston, Richmond, CA (US)

(72) Inventor: Troy Houston, Richmond, CA (US)

(21) Appl. No.: 14/575,431

(22) Filed: Dec. 18, 2014

(51) Int. Cl. B25B 13/50; B25B 13/10

(52) U.S. Cl. CPC B25B 13/5041; B25B 13/10

(57) ABSTRACT

A changeable pipe wrench for selectively interchanging and employing discrete engaging surface styles through a single wrench. The changeable pipe wrench comprises a wrench base, an adjustable jaw, a first reversible attachment component, a second reversible attachment component, and a rivet for each of said reversible attachment components. The wrench base and adjustable jaw are configured to receive and operate with a one of said reversible attachment components, typically with the smooth side on each facing or the tooth side on each facing. One of the reversible attachment components is attached to the wrench base through a base attachment slot disposed on the wrench base fastened with a rivet. The other reversible attachment components is attached to the adjustable jaw through a jaw attachment slot disposed on the adjustable jaw and fastened with a rivet.

### BACKGROUND OF THE INVENTION

1. Field of the Invention

This invention relates generally to tool accessories and, more particularly, to a pipe wrench having a selectively deployable smooth engaging surface and tooth engaging surface.

2. Description of the Prior Art

The use and design of various types of wrenches to provide grip and/or mechanical advantage is well known. A common wrench design is that of a pipe wrench, which is typically includes an adjustable jaw configured to be locked in the frame such that any forward pressure on the handle tends to pull the jaws tighter together. Pipe wrenches may include teeth on its engaging surface, whether angled or straight, or possibly a smooth engaging surface suitable for use on other fittings. A problem which still exists, however, is that a single pipe wrench typically includes teeth that are oriented a particular fixed way or a smooth surface that is not interchangeable. Thus, there remains a need for a pipe wrench that utilizes a changeable engaging surface so as to allow a user to selectively deploy a toothed engaging surface or a smooth engaging surface. It would be helpful if such a changeable pipe wrench eliminated the need for a user to carry multiple styles of pipe wrenches to ensure having a suitable engaging surface. It would be additionally desirable for such a changeable pipe wrench to include attachments for both the fixed side of the engaging surface and the adjustable side of the engaging surface to enable a full or partial engaging surface conversion as desired by a user.

The Applicant's invention described herein provides for a changeable pipe wrench adapted to allow a user to configure a single pipe wrench into several distinct engaging surface styles. The primary components in Applicant's rotating changeable pipe wrench are a wrench base, an adjustable jaw, and two reversible attachment components. When in operation, the changeable pipe wrench enables a user to deploy one of several different engaging surfaces without needing different pipe wrenches. As a result, many of the limitations imposed by prior art structures are removed.

### SUMMARY OF THE INVENTION

A changeable pipe wrench for selectively interchanging and employing discrete engaging surface styles through a single wrench. The changeable pipe wrench comprises a wrench base and adjustable jaw for providing a means for turning pipes and fittings with a rounded surface, a first reversible attachment component for providing a reversible base means for engaging, a second reversible attachment component for providing a reversible jaw means for engaging, and a rivet for each of said reversible attachment components. The wrench base and adjustable jaw are configured to receive and operate with a one of said reversible attachment components, typically with the smooth side on each facing or the tooth side on each facing. One of the reversible attachment components is attached to the wrench base through a base attachment slot disposed on the wrench base fastened with a rivet. The other reversible attachment components is attached to the adjustable jaw through a jaw attachment slot disposed on the adjustable jaw and fastened with a rivet. In this regard, the attachment slots and rivets provide an attachment means for securing. The adjustable is attached to and operated by the wrench base through a conventional adjustable jaw sliding track. By using the different sides of the reversible attachment components, the engaging surface of the changeable pipe wrench can be adjusted to suit whatever task the user is performing. Accordingly, a separate wrench for work with separate engaging surfaces is not required.

It is an object of this invention to provide a pipe wrench that utilizes a changeable engaging surface so as to allow a user to selectively deploy a toothed engaging surface or a smooth engaging surface.

It is another object of this invention to provide a changeable pipe wrench that eliminated the need for a user to carry multiple styles of pipe wrenches to ensure having a suitable engaging surface.

It is yet another object of this invention to provide a changeable pipe wrench that includes attachments for both the fixed side of the engaging surface and the adjustable side of the engaging surface to enable a full or partial engaging surface conversion as desired by a user.

These and other objects will be apparent to one of skill in the art.

### BRIEF DESCRIPTION OF THE DRAWINGS

FIG. 1A is a side elevational view of a changeable pipe wrench built in accordance with the present invention having tooth attachment components installed and the base attachment component and jaw tooth component partially in shadow.

FIG. 1B is a side elevational view of a changeable pipe wrench built in accordance with the present invention having smooth attachment components installed and the base attachment component and jaw smooth component partially in shadow.

FIG. 2A is a front elevational view of a cross section of the wrench base of a changeable pipe wrench built in accordance with the present invention.

FIG. 2B is a top plan view of the wrench base of a changeable pipe wrench built in accordance with the present invention.

FIG. 3 is a front elevational view of a cross section of the adjustable jaw of a changeable pipe wrench built in accordance with the present invention.

FIG. 4A is a side elevational view of the tooth attachment components of a changeable pipe wrench built in accordance with the present invention.

FIG. 4B is a side elevational view of the smooth attachment components of a changeable pipe wrench built in accordance with the present invention.

### DETAILED DESCRIPTION OF THE INVENTION

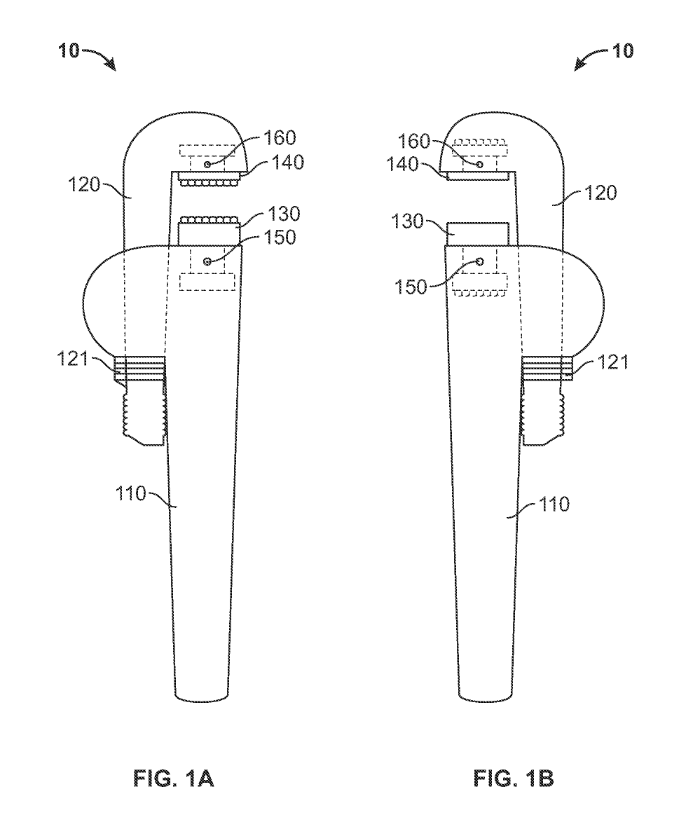

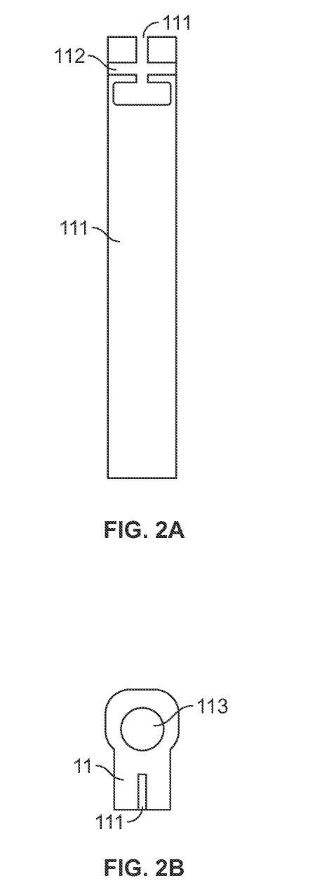

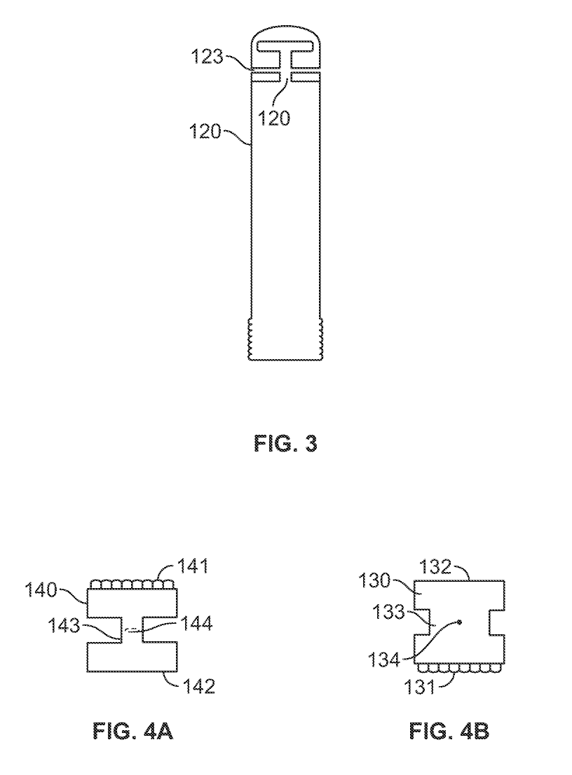

Referring now to the drawings and in particular FIGS. 1A, 1B, 2A, 2B, 3, 4A, and 4B, a changeable pipe wrench 100 is shown having a wrench base 110, an adjustable jaw 120, a first reversible attachment component 130, a second reversible attachment component 140, a first rivet 150 and a second rivet 160. The wrench base 110 is constructed as the base of a conventional pipe wrench except that it includes an inverted “T” shaped attachment slot 111 in which the first reversible attachment component 130 is received and a rivet aperture 112 that enables the removable fastening of the first reversible attachment component 130. The wrench base 110 additionally includes an adjustable jaw sliding track 113 that enables the the adjustable jaw 120 to be slid up and down by the operation of an adjustment screw 121, thereby adjusting the space between the wrench base 110 and the adjustable jaw 120. The wrench base 110 in accordance with the present invention additionally allows the adjustable jaw 120, to be slid all the way out and interchanged with alternate jaws.

The adjustable jaw 120 includes an inverted “T” shaped attachment slot 122 in which the second reversible attachment component 140 is received and a rivet aperture 123 that enables the removable fastening of the second reversible attachment component 140.

The first reversible attachment component 130 and second reversible attachment component 140 are identical structures that each include a component tooth side 131, 141 and a component smooth side 132, 142 either of which may be faced outwardly from the wrench base 110 or adjustable jaw 120 when the first or second reversible attachment component 130, 140 is attached thereto (as illustrated in FIGS. 1A and 1B. The first or second reversible attachment component 130, 140 are attached with the desired side up by placing its attachment ridge 133, 143 in the target attachment slot 111, 122 and inserting a rivet 150, 160. The attachment ridge 133, 143 includes a ridge aperture 134, 144 therein that, when the first or second reversible attachment component 130, 140 is properly positioned on the wrench base 110 or adjustable jaw 120, aligns with the rivet aperture 112, 123 to allow the rivet 150, 160 employed to attach the first or second reversible attachment component 130, 140 to extend there through. In this regard, the first or second reversible attachment component 130, 140 in accordance with the present invention can be attached to the wrench base 110 or the adjustable jaw.

The instant invention has been shown and described herein in what is considered to be the most practical and preferred embodiment. It is recognized, however, that departures may be made therefrom within the scope of the invention and that obvious modifications will occur to a person skilled in the art.

What is claimed is:

1. A changeable pipe wrench, comprising:
a wrench base having an adjustable jaw sliding track and a base attachment slot;
an adjustable jaw having a jaw attachment slot and configured to be movably disposed in the adjustable jaw sliding track;
a first reversible attachment component configured to be fixedly attached in the base attachment slot; and
a second reversible attachment component configured to be fixedly attached in the jaw attachment slot.

2. The changeable pipe wrench of claim 1, additionally comprising a first rivet and a second rivet, wherein said wrench base includes a base rivet aperture that intersects said base attachment slot and receives said first rivet with the first rivet extending through the wrench base from one side to the other and said adjustable jaw includes a jaw rivet aperture that intersects said jaw attachment slot and receives said second rivet with the second rivet extending through the adjustable jaw from one side to the other.

3. The changeable pipe wrench of claim 1, wherein said first reversible attachment component and said second reversible attachment component include distinct engaging surfaces.

4. The changeable pipe wrench of claim 1, wherein said first reversible attachment component and said second reversible attachment component are identical.

5. The changeable pipe wrench of claim 4, wherein said first reversible attachment component and said second reversible attachment component each include a tooth engaging surface and a smooth engaging surface.

6. A changeable pipe wrench, comprising:
a means for turning pipes and fittings with a rounded surface;
a reversible base means for engaging removably disposed on said a means for turning pipes and fittings with a rounded surface; and
a reversible jaw means for engaging removably disposed on said a means for turning pipes and fittings with a rounded surface.

7. The changeable pipe wrench of claim 6, wherein said means for turning pipes and fittings with a rounded surface and the base means include an attachment means for securing.
